(19) United States
(12) Patent Application Publication
(10) Pub. No.: US 2026/0267704 A1
(43) Pub. Date: Sep. 10, 2026

(54) Method and System for Positioning a Node

(71) Applicant: Buddy Njere, Bala Cynwyd, PA (US)

(72) Inventor: Buddy Njere, Bala Cynwyd, PA (US)

(21) Appl. No.: 19/556,265

(22) Filed: Mar. 4, 2026

Related U.S. Application Data
(60) Provisional application No. 63/766,560, filed on Mar. 4, 2025.

(51) Int. Cl. G06F 9/50

(52) U.S. Cl. CPC G06F 9/5038; G06F 2209/5022

(57) ABSTRACT

The present invention relates to a method for re-positioning a node in a queue, wherein the queue comprises a plurality of nodes, and wherein the method comprises receiving, from the node, a request for re-positioning, and allocating each of a plurality of resources to at least some of the plurality of nodes. The present invention also relates to a system for performing the method and to a corresponding computer program product.

### CROSS-REFERENCE TO RELATED APPLICATIONS

This application claims the benefit of U.S. Provisional Application No. 63/766,560, filed Mar. 4, 2025, the entire contents of which are hereby incorporated by reference.

### FIELD

The present invention relates to the field of resource management. More particularly, it relates to a system and a method for positioning nodes in a queue to allocate resources simply and more efficiently.

### BACKGROUND

Efficient resource allocation is a fundamental challenge across a wide range of industries and applications, including computing, telecommunications, transportation, and logistics. In many systems, resources such as processing power, memory, bandwidth, storage, or physical assets, such as space, may be limited, and may have to be optimally allocated to meet dynamic demands, maximize performance, or minimize operational costs. Traditional resource allocation methods may often rely on predefined rules, static models, or human intervention, which can be inefficient or unable to adapt to real-time changes in demand and availability. In complex environments, where resources and demands may both be highly variable, such static approaches may lead to underutilization of resources, increased latency, and bottlenecks that may degrade overall system performance. Accordingly, there is a need for improved methods of resource allocation that can dynamically respond to fluctuating conditions, optimize resource utilization, and enhance system efficiency. The present invention addresses these challenges by providing a method for allocating resources that may be more adaptable, scalable, and capable of optimizing resource use in real-time.

In particular, in industries where assets have to be allocated sequentially or “in-order,” such as logistics, warehousing, manufacturing, and data storage, efficient resource allocation may be essential to maintaining smooth operations and maximizing productivity. For example, in a warehouse, storage spaces may need to be allocated in a specific order to facilitate orderly retrieval, minimize travel time, or support first-in, first-out (FIFO) inventory management. In manufacturing environments, workstations, storage areas, or equipment may have to be allocated in a precise sequence to ensure that production flows seamlessly, minimizing downtime between stages and reducing bottlenecks.

Traditional methods of in-order resource allocation may often rely on manual scheduling, predefined layout plans, or fixed rules that dictate asset distribution based on forecasted demand or standardized processes. However, these approaches may lack flexibility and may struggle to adapt to real-time changes in demand, asset availability, or unexpected operational disruptions. For example, in a distribution center, a sudden increase in orders or a change in delivery schedules can disrupt the intended order of space allocation, resulting in delays, inefficient asset utilization, and increased operational costs.

In industries where assets are allocated sequentially, even minor inefficiencies can cascade through the system, leading to compounding delays and increased labor or handling costs. A rigid allocation method may also limit the system's ability to respond to variable order sizes, fluctuating inventory levels, or shifts in production priorities. These constraints underscore the need for a dynamic allocation method that can adjust in real time to maintain order, optimize space or asset utilization, and adapt to changing operational demands without sacrificing efficiency.

The present invention addresses these challenges by introducing a method for allocating resources in an ordered sequence, designed to enhance flexibility, improve resource utilization, and reduce delays. By enabling dynamic, real-time adjustments to sequential allocation, the present technology may offer a solution that may accommodate variability and enhance operational flow across a range of applications where in-order resource allocation is of relevance.

### SUMMARY

In light of the above, it is an aim of the present invention to provide a system and a method that may allow for allocation of resources more efficiently and simply. In particular, embodiments of the present technology may allow positioning of nodes in a queue, representing an order in which resources are to be allocated, such that resources can be more efficiently utilized.

According to a first aspect, the present invention relates to a method for re-positioning a node in a queue, wherein the queue comprises a plurality of nodes, and wherein the method comprises receiving, from the node, a request for re-positioning. Each of the plurality of nodes may correspond to a human or any other autonomous entity. For example, as described further below, each node may correspond to an autonomous vehicle. Generally, nodes may correspond to any entity that may have to make use of a resource common with another entity. Further exemplarily, nodes may correspond to senders of orders to a manufacturing plant.

Each of the plurality of nodes in the queue may be associated with a position.

The position may relate, at least in part, to an order in which each of a plurality of resources may be allocated to at least some of the plurality of nodes. In other words, each of a plurality of resources may be allocated to some of the nodes (the number of which may be higher than the number of resources), each resource being allocated to one node, and the position in the queue may indicate the order in which the resources are to be allocated. For example, the first position in the queue may indicate the first, in time, node to which a resource will be allocated, the second position indicating the second node to which a resource will be allocated, and so on.

Any one of the plurality of resources may be, at least significantly, identical to any other of the plurality of resources. For example, the plurality of resources may correspond to a plurality of entry tickets to a venue. Alternatively, the plurality of resources may correspond to a plurality of time units of a machine, for example, at a manufacturing plant.

Further alternatively, the plurality of resources may correspond to a plurality of free sections that will open up ahead of a pre-defined number of vehicles in a lane. In other words, for example, a plurality of vehicles may be queued up in the lane and consider the pre-defined number of vehicles to equal 10. Then, once the 11^{th} vehicle ahead of a defined vehicle moves, a free section opens up ahead of 10 vehicles in the lane. The defined vehicle may then request re-positioning to the first position among the 10 intermediary vehicles to occupy the free section that opens up.

The position associated with a node may be related, at least in part, to an order in which each of the plurality of resources is to be allocated to each of the plurality of nodes.

The plurality of nodes may comprise a node associated with a first position, wherein the node associated with the first position may correspond to a node to which a next of the plurality of resources may be allocated.

Re-positioning the node may comprise associating the first position with the re-positioned node, corresponding to the re-positioned node becoming the node to which the next of the plurality of resources may be allocated. In other words, the re-positioned node is moved to the front of the queue, with other nodes being moved back.

The method may comprise changing the position associated with a defined node.

The defined node may be different from the re-positioned node. In other words, the defined node corresponds to a node the position of which is changed due to re-positioning, to the first position, of the re-positioned node.

Changing the position of the defined node may comprise incrementing the position, corresponding to a delay in allocating a resource to the defined node.

The method may comprise changing the position of the defined node in response to associating the first position with the re-positioned node.

The plurality of resources as described above may comprise a next resource, the next resource corresponding to the resource to be allocated next.

The method may comprise receiving the request for re-positioning before the next resource is allocated.

The method may comprise receiving a start signal.

The method may comprise receiving a stop signal.

The method may comprise disallowing the request if the request is received before the start signal may be received.

The method may comprise disallowing the request if the request is received after the stop signal may be received.

The request may comprise a value.

Re-positioning the node may be based, at least in part, on the value. In particular, a node that sent a request comprising a highest value may be re-positioned.

The method may comprise determining if the request satisfies a re-positioning condition. In particular, determining if the request satisfies the re-positioning condition may comprise, at least in part, determining if the request satisfies a validity condition and if the request satisfies an allocation condition, as described further below.

The determination if the request satisfies a re-positioning condition may be based, at least in part, on the value.

A result of the determination if the request satisfies a re-positioning condition may correspond to one of success or failure.

The method may comprise, in response to the result of the determination if the request satisfies a re-positioning condition being success, re-positioning the node.

The method may comprise receiving a plurality of requests for re-positioning.

The plurality of requests may be received from a plurality of the plurality of nodes.

Each of the plurality of requests may comprise a value.

The method may comprise assigning a rank to the request based, at least in part, on the value comprised in the request.

The method may comprise comparing a first of the plurality of requests with a second of the plurality of requests.

The comparison of the first and the second of the plurality of requests may be based, at least in part, on the values comprised in the first and the second requests. In particular, a request comprising a higher value may be ranked higher than a request comprising a lower value.

The request to which the rank may be assigned, as described above, may correspond to the first/second request, and the method may comprise assigning the rank based, at least in part, on the comparison of the first request with the second request.

The method may comprise assigning a rank to each of the plurality of requests.

The determination if the request satisfies the re-positioning condition may be based, at least in part, on the rank assigned to the request.

The determination if the request satisfies the re-positioning condition may be based, at least in part, on determining if the rank assigned to the request corresponds to a highest rank. In other words, the node that sent the request with the highest rank is re-positioned to the first position.

The method may comprise determining if the request satisfies an allocation condition comprising determining if the value exceeds an allocation threshold.

The determination if the request satisfies the re-positioning condition may be based, at least in part, on a result of the determination if the value exceeds the allocation threshold.

The allocation threshold may comprise a static threshold. A static threshold may be of advantage in improving an efficiency of performing the method as the same static threshold may always be used.

The allocation threshold may comprise a dynamic threshold. A dynamic threshold may improve robustness of the method as it may account for a current state.

The allocation threshold may be configured to vary based, at least in part, on a number of resources yet to be allocated. In particular, the allocation threshold may vary inversely with the number of resources yet to be allocated indicative of a rising value of the next resource as the number of resources dwindles.

The allocation threshold may be configured to vary based, at least in part, on a number of nodes in the queue. In particular, the allocation threshold may vary proportionally to the number of nodes in the queue indicative of a rising value of the next resource as the number of nodes in the queue rises.

The allocation threshold may be configured to vary based, at least in part, on a value comprised in a previous request for which the result of the determination if the request satisfied a re-positioning condition corresponded to success.

The allocation threshold may be configured to vary based, at least in part, on values comprised in each of a plurality of previous requests for each of which the result of the determination if the request satisfied a re-positioning condition corresponded to success. In particular, the allocation threshold may be based, at least in part, based on a statistical measure of values comprised in requests that previously satisfied the re-positioning condition. For example, the allocation threshold may be an average of values comprised in such previous requests. The previous requests considered for determining the statistical measure may be chosen based, for example, on any of a time of day at which the request was sent, a date on which the request was sent, a weather condition at the time the request was sent, a type of resource such as a seat in a theater or an entry ticket to a club or re-positioning with respect to a pre-defined number of vehicles being allocated to the nodes, or other suitable criteria.

The method may comprise receiving the allocation threshold.

In the following, various aspects will be described with respect to the allocation threshold. It may be understood that similar aspects apply also for the validation threshold mutatis mutandis.

Alternatively, the method may comprise determining the allocation threshold. Determination may be based on values comprised in previous requests as described above.

The method may comprise determining the allocation threshold based, at least in part, on an expected number of nodes in the queue. Determination may also be based, however, on an expected number of nodes and/or resources yet to be allocated, as described further below, in the queue. This may be of advantage in cases where the actual number of nodes in the queue may not be easily and/or reliably determined. Further, the expected number of nodes in the queue may be determined in advance and may, thus, allow for improved efficiency.

The method may comprise determining the allocation threshold based, at least in part, on a temporal variation of an expected number of nodes in the queue.

The method may comprise determining the allocation threshold based, at least in part, on an expected number of resources yet to be allocated.

The method may comprise determining the allocation threshold based, at least in part, on a temporal variation of an expected number of resources yet to be allocated.

The method may comprise determining if the request satisfies a validity condition.

Determining if the request satisfies a validity condition may comprise determining if the value meets/exceeds a validity threshold. The validity threshold may, thus, indicate a minimum value for the next resource.

The method may comprise, in response to the value being less than the validity threshold, disallowing the request. This may be of advantage in improving an efficiency of the method as fewer requests may have to be considered.

The validity threshold may comprise a static threshold.

The validity threshold may comprise a dynamic threshold.

The validity threshold may be configured to vary based, at least in part, on a number of resources yet to be allocated.

The validity threshold may be configured to vary based, at least in part, on a number of nodes in the queue.

The validity threshold may be configured to vary based, at least in part, on a value comprised in a previous request for which the result of the determination if the request satisfied a re-positioning condition corresponded to success.

The validity threshold may be configured to vary based, at least in part, on values comprised in each of a plurality of previous requests for each of which the result of the determination if the request satisfied a re-positioning condition corresponded to success.

The method may comprise receiving the validity threshold.

Alternatively, the method may comprise determining the validity threshold.

The method may comprise determining the validity threshold based, at least in part, on an expected number of nodes in the queue.

The method may comprise determining the validity threshold based, at least in part, on a temporal variation of an expected number of nodes in the queue.

The method may comprise determining the validity threshold based, at least in part, on an expected number of resources yet to be allocated.

The method may comprise determining the validity threshold based, at least in part, on a temporal variation of an expected number of resources yet to be allocated.

Determining if the request satisfies a validity condition may comprise determining if a time at which the request is received is not earlier than a start time. The start time may, for example, be coincident with receipt of the start signal described above.

Determining if the request satisfies a validity condition may comprise determining if a time at which the request is received is not later than an end time. The end time may, for example, be coincident with receipt of the stop signal described above.

The method may comprise sending a notification related, at least in part, to a result of the determination if the request satisfies a re-positioning condition.

The method may comprise, in response to the determination if the request satisfies a re-positioning condition being success, generating a readable code. The code may, in particular, be readable by a code scanning component as described further below.

The code may comprise any of a bar code, a QR-code, a matrix data code, or any other suitable code.

The code may comprise a human and/or a machine-readable code.

Allocating any of the plurality of resources may comprise reading the readable code.

The method may comprise disallowing the request if the request is received after a defined time interval has elapsed since reading the last readable code. In other words, requests that are allowed may have to be received within the defined time interval since reading the last readable code.

The defined time interval may comprise a fixed time interval.

A length of the defined time interval may be less than 5 minutes, preferably less than 3 minutes, further preferably less than 2 minutes.

The defined time interval may be based, at least in part, on a time required for allocating a resource previously.

Time required for allocating a resource may be determined, for example, by recording a time at which the readable code is read and a time at which the resource is allocated to the node with the request satisfying the re-positioning condition. In particular, the time required for allocating a resource may be a difference between the two recorded times.

The defined time interval may be a dynamic time interval.

The dynamic time interval may be based, at least in part, on a statistical moment of times required previously for allocating a plurality of resources. For example, an average of times required previously for allocating a plurality of resources may be determined and the dynamic time interval may be based, at least in part, on the average of times.

Each of the plurality of resources allocated may be associated with a distributor identifier. For example, the distributor identifier may allow identification of a distributor offering the plurality of resources. The generated code, as described above, may comprise information relating to the distributor identifier allowing identification of the distributor. Further, the request for re-positioning may additionally comprise the distributor identifier.

The method may further comprise determining a time at which a resource is allocated to a node.

The dynamic time interval may be based, at least in part, on a time interval between two resources associated with the same distributor identifier (previously) allocated successively. The time interval between two resources associated with the same distributor identifier previously allocated successively may indicate an amount of time needed to allocate a resource and may, thus, be used, as also described above, to inform the value of the dynamic time interval.

The method may be a computer-implemented method.

According to a second aspect, the present invention relates to a system for re-positioning a node in a queue, wherein the queue comprises a plurality of nodes, and wherein the system is configured to receive, from the node, a request for re-positioning.

Each of the plurality of nodes in the queue may be associated with a position.

The position may relate, at least in part, to an order in which each of a plurality of resources is to be allocated to each of the plurality of nodes.

Any one of the plurality of resources may be, at least significantly, identical to any other of the plurality of resources.

The position associated with a node may be related, at least in part, to an order in which each of the plurality of resources may be allocated to each of the plurality of nodes.

The plurality of nodes may comprise a node associated with a first position, wherein the node associated with the first position may correspond to a node to which a next of the plurality of resources may be allocated.

Re-positioning the node may comprise associating the first position with the re-positioned node, corresponding to the re-positioned node becoming the node to which the next of the plurality of resources may be allocated.

The system may be configured to change the position associated with a defined node.

The defined node may be different from the re-positioned node.

Changing the position may comprise incrementing the position, corresponding to a delay in allocating a resource to the defined node.

The system may be configured to change the position of the defined node in response to associating the first position with the node.

The plurality of resources may comprise a next resource, the next resource corresponding to the resource to be allocated next.

The system may be configured to receive the request for re-positioning before the next resource may be allocated.

The system may be configured to receive a start signal.

The system may be configured to receive a stop signal.

The system may be configured to disallow the request if the request is received before the start signal may be received.

The system may be configured to disallow the request if the request is received after the stop signal may be received.

The system may comprise a communication component configured to receive the request.

The communication component may be configured to receive the start signal.

The communication component may be configured to receive the stop signal.

The system may comprise a data processing component.

The communication component may be configured to communicate with the data processing component.

The communication component may be configured to send any of the request, the start signal, and the stop signal to the data processing component.

The system may comprise a memory component.

The memory component may be configured to communicate with the data processing component.

The request may comprise a value.

Re-positioning the node may be based, at least in part, on the value.

The system, particularly the data processing component thereof, may be configured to determine if the request satisfies a re-positioning condition.

The determination if the request satisfies a re-positioning condition may be based, at least in part, on the value.

A result of the determination if the request satisfies a re-positioning condition corresponds to one of success or failure.

The system may be configured to, in response to the result of the determination if the request satisfies a re-positioning condition being success, re-position the node.

The system, particularly the communication component thereof, may be configured to receive a plurality of requests for re-positioning.

Each of the plurality of requests may be received from one of the plurality of nodes.

Each of the plurality of requests may comprise a value.

The system, particularly the data processing component thereof, may be configured to assign a rank to the request based, at least in part, on the value comprised in the request.

The system, particularly the data processing component thereof, may be configured to compare a first of the plurality of requests with a second of the plurality of requests.

The comparison of the first and the second of the plurality of requests may be based, at least in part, on the values comprised in the first and the second requests.

The request to which the rank is assigned, as described above, may correspond to the first/second request, and the system may be configured to assign the rank based, at least in part, on the comparison of the request with another request.

The system, particularly the data processing component thereof, may be configured to assign a rank to each of the plurality of requests.

The determination if the request satisfies the re-positioning condition may be based, at least in part, on the rank assigned to the request.

The determination if the request satisfies the re-positioning condition may be based, at least in part, on determining if the rank assigned to the request corresponds to a highest rank.

The system, particularly the data processing component thereof, may be configured to determine if the value exceeds an allocation threshold.

The determination if the request satisfies the re-positioning condition may be based, at least in part, on a result of the determination if the value exceeds the allocation threshold.

The allocation threshold may comprise a static threshold.

The allocation threshold may comprise a dynamic threshold.

The allocation threshold may be configured to vary based, at least in part, on a number of resources yet to be allocated.

The system may comprise a resource capturing component, wherein the resource capturing component may be configured to determine a number of resources yet to be allocated at any moment of time.

The allocation threshold may be configured to vary based, at least in part, on a number of nodes in the queue.

The system may comprise a queue capturing component configured to determine a length of the queue at any moment of time.

The allocation threshold may be configured to vary based, at least in part, on a value comprised in a previous request for which the result of the determination if the request satisfied a re-positioning condition corresponded to success.

The allocation threshold may be configured to vary based, at least in part, on values comprised in each of a plurality of previous requests for each of which the result of the determination if the request satisfied a re-positioning condition corresponded to success.

The system may be configured to receive the allocation threshold.

The system may be configured to determine the allocation threshold.

The system may be configured to determine the allocation threshold based, at least in part, on an expected number of nodes in the queue.

The system may be configured to determine the allocation threshold based, at least in part, on a temporal variation of an expected number of nodes in the queue.

The system may be configured to determine the allocation threshold based, at least in part, on an expected number of resources yet to be allocated.

The system may be configured to determine the allocation threshold based, at least in part, on a temporal variation of an expected number of resources yet to be allocated.

The system may be configured to determine if the value meets/exceeds a validity threshold.

The system may be configured, in response to the value being less than the validity threshold, to disallow the request.

The validity threshold may comprise a static threshold.

The validity threshold may comprise a dynamic threshold.

The validity threshold may be configured to vary based, at least in part, on a number of resources yet to be allocated.

The validity threshold may be configured to vary based, at least in part, on a number of nodes in the queue.

The validity threshold may be configured to vary based, at least in part, on a value comprised in a previous request for which the result of the determination if the request satisfied a re-positioning condition corresponded to success.

The validity threshold may be configured to vary based, at least in part, on values comprised in each of a plurality of previous requests for each of which the result of the determination if the request satisfied a re-positioning condition corresponded to success.

The system may be configured to receive the validity threshold.

The system may be configured to determine the validity threshold.

The system may be configured to determine the validity threshold based, at least in part, on an expected number of nodes in the queue.

The system may be configured to determine the validity threshold based, at least in part, on a temporal variation of an expected number of nodes in the queue.

The system may be configured to determine the validity threshold based, at least in part, on an expected number of resources yet to be allocated.

The system may be configured to determine the validity threshold based, at least in part, on a temporal variation of an expected number of resources yet to be allocated.

The system may be configured to send a notification related, at least in part, to a result of the determination.

The system may be configured, in response to the determination if the request satisfies a re-positioning condition being success, to generate a readable code.

The code may comprise any of a bar code, a QR-code, a matrix data code, or any other suitable code.

The code may comprise a human and/or machine-readable code.

The system may comprise a code scanning component configured to scan a readable code.

Allocating any of the plurality of resources may comprise reading the readable code.

The system may be configured to disallow the request if the request may be received after a defined time interval has elapsed since reading the last readable code.

The defined time interval may comprise a fixed time interval.

A length of the defined time interval may be less than 5 minutes, preferably less than 3 minutes, further preferably less than 2 minutes.

The defined time interval may be based, at least in part, on a time required for allocating a resource previously.

The defined time interval may be a dynamic time interval.

The dynamic time interval may be based, at least in part, on a statistical moment of times required for allocating a plurality of resources previously.

Each of the plurality of resources allocated may be associated with a distributor identifier.

The system may be further configured to determine a time at which each of the plurality of resources may be allocated to a node.

The dynamic time interval may be based, at least in part, on a time interval between two resources associated with the same distributor identifier allocated successively.

Each of the plurality of nodes may correspond to a vehicle, particularly an autonomous vehicle.

The plurality of available resources may correspond to a plurality of free sections that will open up ahead of a pre-defined number of vehicles in a lane allowing re-positioning of a vehicle. The pre-defined number of vehicles may be set by a traffic authority, for example. Alternatively, multiple resources may be defined by varying the pre-defined number of vehicles. The validity and/or allocation thresholds may then vary based, at least in part, on the pre-defined number of vehicles (thus, type of resource) for any given resource.

The generated code as described above may comprise information allowing the (autonomous) vehicle to be identified.

The generated code may comprise a timestamp.

The system may be configured to send the generated code to a central control system of the (autonomous) vehicle.

The system may be configured to send the generated code to the (autonomous) vehicle.

The system may be configured to perform the method as described above.

According to a fourth aspect, the present invention relates to a central control system configured to control at least one (autonomous) vehicle, wherein the central control system comprises a central communication component, the central communication component configured to communicate with each of the at least one (autonomous) vehicle.

The central communication component may be configured to communicate with a system as described above.

The central control system may be configured to receive a code from the system.

The central control system may be configured, in response to receiving the code, to allow the at least one vehicle to move to a dedicated lane allowing for re-positioning of the at least one vehicle.

According to a fifth aspect, the present invention relates to a computer program product comprising instructions, when run on a data processing component of a system as described above, to cause the system to perform the method as described above.

According to a sixth aspect, the present invention relates to a computer program product comprising instructions, when run on a data processing unit of a computer, to cause the computer to perform the method as described above.

The present invention is also described by the following numbered embodiments.

Below method embodiments will be discussed. These are abbreviated by the letter “M” followed by a number. Whenever reference is herein made to the “method embodiments”, the following embodiments are meant.
M1. A method for re-positioning a node in a queue, wherein the queue comprises a plurality of nodes, and wherein the method comprises:
   receiving, from the node, a request for re-positioning.
M2. The method according to the preceding embodiment, wherein each of the plurality of nodes in the queue is associated with a position.
M2.1. The method according to any of the preceding method embodiments, wherein the method comprises allocating each of a plurality of resources to at least some of the plurality of nodes.
M3. The method according to the preceding embodiment and with the features of embodiment M2, wherein the position relates, at least in part, to an order in which each of the plurality of resources is to be allocated to each of the plurality of nodes.
M4. The method according to the preceding embodiment, wherein any one of the plurality of resources is, at least significantly, identical to any other of the plurality of resources.
M5. The method according to any of the 2 preceding embodiments and with the features of embodiment M2, wherein the position associated with a node is related, at least in part, to an order in which each of the plurality of resources is to be allocated to each of the plurality of nodes.
M6. The method according to the preceding embodiment, wherein the plurality of nodes comprises a node associated with a first position, wherein the node associated with the first position corresponds to a node to which a next of the plurality of resources is allocated.
M7. The method according to the preceding embodiment, wherein re-positioning the node comprises associating the first position with the re-positioned node, corresponding to the re-positioned node becoming the node to which the next of the plurality of resources is allocated.
M8. The method according to any of the preceding method embodiments and with the features of embodiment M2, wherein the method comprises changing the position associated with a defined node.
M9. The method according to the preceding embodiment, wherein the defined node is different from the re-positioned node.
M10. The method according to the preceding embodiment and with the features of embodiment M3, wherein changing the position comprises incrementing the position, corresponding to a delay in allocating a resource to the defined node.
M11. The method according to any of the 2 preceding method embodiments and with the features of embodiment M7, wherein the method comprises changing the position of the defined node in response to associating the first position with the re-positioned node.
M12. The method according to any of the preceding method embodiments and with the features of embodiment M3, wherein the plurality of resources comprises a next resource, the next resource corresponding to the resource to be allocated next.
M13. The method according to the preceding embodiment, wherein the method comprises receiving the request for re-positioning before the next resource is allocated.
M14. The method according to any of the preceding method embodiments, wherein the method comprises receiving a start signal.
M15. The method according to any of the preceding method embodiments, wherein the method comprises receiving a stop signal.
M16. The method according to any of the preceding method embodiments and with the features of embodiment M14, wherein the method comprises disallowing the request if the request is received before the start signal is received.
M17. The method according to any of the preceding method embodiments and with the features of embodiment M15, wherein the method comprises disallowing the request if the request is received after the stop signal is received.
M18. The method according to any of the preceding method embodiments, wherein the request comprises a value.
M19. The method according to the preceding embodiment, wherein re-positioning the node is based, at least in part, on the value.
M20. The method according to any of the preceding method embodiments, wherein the method comprises determining if the request satisfies a re-positioning condition.
M21. The method according to the preceding embodiment and with the features of embodiment M18, wherein the determination if the request satisfies a re-positioning condition is based, at least in part, on the value.
M22. The method according to any of the 2 preceding embodiments, wherein a result of the determination if the request satisfies a re-positioning condition corresponds to one of success or failure.
M23. The method according to the preceding embodiment, wherein the method comprises, in response to the result of the determination if the request satisfies a re-positioning condition being success, re-positioning the node.
M24. The method according to any of the preceding method embodiments, wherein the method comprises receiving a plurality of requests for re-positioning.
M25. The method according to the preceding embodiment, wherein the plurality of requests is received from a plurality of the plurality of nodes.
M26. The method according to any of the 2 preceding embodiments and with the features of embodiment M18, wherein each of the plurality of requests comprises a value.
M27. The method according to any of the preceding method embodiments and with the features of embodiment M18, wherein the method comprises assigning a rank to the request based, at least in part, on the value comprised in the request.
M28. The method according to any of the preceding method embodiments and with the features of embodiment M24, wherein the method comprises comparing a first of the plurality of requests with a second of the plurality of requests.
M29. The method according to the preceding embodiment and with the features of the embodiment M26, wherein the comparison of the first and the second of the plurality of requests is based, at least in part, on the values comprised in the first and the second requests.
M30. The method according to the preceding embodiment and with the features of the embodiment M27, wherein the request corresponds to the first/second request, and wherein the method comprises assigning the rank based, at least in part, on the comparison of the first request with the second request.
M31. The method according to any of the preceding method embodiments and with the features of embodiment M24, wherein the method comprises assigning a rank to each of the plurality of requests.
M32. The method according to any of the preceding method embodiments and with the features of embodiment M27, wherein the determination if the request satisfies the re-positioning condition is based, at least in part, on the rank assigned to the request.
M33. The method according to the preceding embodiment, wherein the determination if the request satisfies the re-positioning condition is based, at least in part, on determining if the rank assigned to the request corresponds to a highest rank.
M34. The method according to any of the preceding method embodiments and with the features of embodiment M18, wherein the method comprises determining if the request satisfies an allocation condition comprising determining if the value exceeds an allocation threshold.
M35. The method according to the preceding embodiment and with the features of embodiment M20, wherein the determination if the request satisfies the re-positioning condition is based, at least in part, on a result of the determination if the value exceeds the allocation threshold.
M36. The method according to any of the 2 preceding embodiments, wherein the allocation threshold comprises a static threshold.
M37. The method according to any of the 3 preceding embodiments but without the features of the preceding embodiment, wherein the allocation threshold comprises a dynamic threshold.
M38. The method according to the preceding embodiment and with the features of embodiment M3, wherein the allocation threshold is configured to vary based, at least in part, on a number of resources yet to be allocated.
M39. The method according to any of the 2 preceding embodiments, wherein the allocation threshold is configured to vary based, at least in part, on a number of nodes in the queue.
M40. The method according to any of the 3 preceding embodiments and with the features of embodiment M22, wherein the allocation threshold is configured to vary based, at least in part, on a value comprised in a previous request for which the result of the determination if the request satisfied a re-positioning condition corresponded to success.
M41. The method according to the preceding embodiment, wherein the allocation threshold is configured to vary based, at least in part, on values comprised in each of a plurality of previous requests for each of which the result of the determination if the request satisfied a re-positioning condition corresponded to success.
M42. The method according to any of the preceding method embodiments and with the features of embodiment M34, wherein the method comprises receiving the allocation threshold.
M43. The method according to any of the preceding method embodiments and with the features of embodiment M34 but without the features of the preceding embodiment, wherein the method comprises determining the allocation threshold.
M44. The method according to the preceding embodiment, wherein the method comprises determining the allocation threshold based, at least in part, on an expected number of nodes in the queue.
M45. The method according to any of the 2 preceding embodiments, wherein the method comprises determining the allocation threshold based, at least in part, on a temporal variation of an expected number of nodes in the queue.
M46. The method according to any of the 3 preceding embodiments and with the features of embodiment M3, wherein the method comprises determining the allocation threshold based, at least in part, on an expected number of resources yet to be allocated.
M47. The method according to any of the 4 preceding embodiments, wherein the method comprises determining the allocation threshold based, at least in part, on a temporal variation of an expected number of resources yet to be allocated.
M48. The method according to any of the preceding method embodiments, wherein the method comprises determining if the request satisfies a validity condition.
M49. The method according to the preceding embodiment and with the features of embodiment M18, wherein determining if the request satisfies a validity condition comprises determining if the value meets/exceeds a validity threshold.
M50. The method according to the preceding embodiment, wherein the method comprises, in response to the value being less than the validity threshold, disallowing the request.
M51. The method according to any of the 2 preceding embodiments, wherein the validity threshold comprises a static threshold.
M52. The method according to any of the 3 preceding embodiments but without the features of the preceding embodiment, wherein the validity threshold comprises a dynamic threshold.
M53. The method according to the preceding embodiment and with the features of embodiment M3, wherein the validity threshold is configured to vary based, at least in part, on a number of resources yet to be allocated.
M54. The method according to any of the 2 preceding embodiments, wherein the validity threshold is configured to vary based, at least in part, on a number of nodes in the queue.
M55. The method according to any of the 3 preceding embodiments and with the features of embodiment M22, wherein the validity threshold is configured to vary based, at least in part, on a value comprised in a previous request for which the result of the determination if the request satisfied a re-positioning condition corresponded to success.
M56. The method according to the preceding embodiment, wherein the validity threshold is configured to vary based, at least in part, on values comprised in each of a plurality of previous requests for each of which the result of the determination if the request satisfied a re-positioning condition corresponded to success.
M57. The method according to any of the preceding method embodiments and with the features of embodiment M48, wherein the method comprises receiving the validity threshold.
M58. The method according to any of the preceding method embodiments and with the features of embodiment M48 but without the features of the preceding embodiment, wherein the method comprises determining the validity threshold.
M59. The method according to the preceding embodiment, wherein the method comprises determining the validity threshold based, at least in part, on an expected number of nodes in the queue.
M60. The method according to any of the 2 preceding embodiments, wherein the method comprises determining the validity threshold based, at least in part, on a temporal variation of an expected number of nodes in the queue.
M61. The method according to any of the 3 preceding embodiments and with the features of embodiment M3, wherein the method comprises determining the validity threshold based, at least in part, on an expected number of resources yet to be allocated.
M62. The method according to any of the 4 preceding embodiments, wherein the method comprises determining the validity threshold based, at least in part, on a temporal variation of an expected number of resources yet to be allocated.
M63. The method according to any of the preceding method embodiments and with the features of embodiment M48, wherein determining if the request satisfies a validity condition comprises determining if a time at which the request is received is not earlier than a start time.
M64. The method according to any of the preceding method embodiments and with the features of embodiment M48, wherein determining if the request satisfies a validity condition comprises determining if a time at which the request is received is not later than an end time.
M65. The method according to any of the preceding method embodiments and with the features of any of embodiments M20, M34, and M48, wherein the method comprises sending a notification related, at least in part, to a result of the determination.
M66. The method according to any of the preceding method embodiments and with the features of embodiment M22, wherein the method comprises, in response to the determination if the request satisfies a re-positioning condition being success, generating a readable code.
M67. The method according to the preceding embodiment, wherein the code comprises any of a bar code, a QR-code, a matrix data code, or any other suitable code comprising a unique identifier.
M68. The method according to any of the 2 preceding embodiments, wherein the code comprises a human and/or a machine-readable code.
M69. The method according to any of the 3 preceding embodiments and with the features of embodiment M3, wherein allocating any of the plurality of resources comprises reading the readable code.
M70. The method according to the preceding embodiment, wherein the method comprises disallowing the request if the request is received after a defined time interval has elapsed since reading the last readable code.
M71. The method according to the preceding embodiment, wherein the defined time interval comprises a fixed time interval.
M72. The method according to the preceding embodiment, wherein a length of the defined time interval is less than 5 minutes, preferably less than 3 minutes, further preferably less than 2 minutes.
M73. The method according to any of the preceding method embodiments and with the features of embodiment M70 but without the features of the preceding embodiment, wherein the defined time interval is based, at least in part, on a time required for allocating a resource previously.

Time required for allocating a resource may be determined, for example, by recording a time at which the readable code is read and a time at which the resource is allocated to the node with the request satisfying the re-positioning condition. In particular, the time required for allocating a resource may be a difference between the two recorded times.
M74. The method according to any of the preceding method embodiments and with the features of embodiment M70 but without the features of embodiment M71, wherein the defined time interval is a dynamic time interval.
M75. The method according to the preceding embodiment, wherein the dynamic time interval is based, at least in part, on a statistical moment of times required previously for allocating a plurality of resources.
M76. The method according to any of the preceding method embodiments and with the features of embodiment M3, wherein each of the plurality of resources allocated is associated with a distributor identifier.
M77. The method according to the preceding embodiment, wherein the method further comprises determining a time at which a resource is allocated to a node.
M78. The method according to the preceding embodiment and with the features of embodiment M74, wherein the dynamic time interval is based, at least in part, on a time interval between two resources associated with the same distributor identifier allocated successively.
M79. The method according to any of the preceding method embodiments, wherein the method is a computer-implemented method.

Below system embodiments will be discussed. These are abbreviated by the letter “S” followed by a number. Whenever reference is herein made to the “system embodiments”, the following embodiments are meant.
S1. A system for re-positioning a node in a queue, wherein the queue comprises a plurality of nodes, and wherein the system is configured to:
   receive, from the node, a request for re-positioning.
S2. The system according to the preceding embodiment, wherein each of the plurality of nodes in the queue is associated with a position.
S3. The system according to any of the preceding system embodiments, wherein the system is configured to allocate each of a plurality of resources to at least some of the plurality of nodes.
S4. The system according to the preceding embodiment and with the features of embodiment S2, wherein the position relates, at least in part, to an order in which each of a plurality of resources is to be allocated to each of the plurality of nodes.
S5. The system according to any of the 2 preceding embodiments, wherein any one of the plurality of resources is, at least significantly, identical to any other of the plurality of resources.
S6. The system according to any of the 2 preceding embodiments and with the features of embodiment S2, wherein the position associated with a node is related, at least in part, to an order in which each of the plurality of resources is to be allocated to each of the plurality of nodes.
S7. The system according to the preceding embodiment, wherein the plurality of nodes comprises a node associated with a first position, wherein the node associated with the first position corresponds to a node to which a next of the plurality of resources is allocated.
S8. The system according to the preceding embodiment, wherein re-positioning the node comprises associating the first position with the re-positioned node, corresponding to the re-positioned node becoming the node to which the next of the plurality of resources is allocated.
S9. The system according to any of the preceding system embodiments and with the features of embodiment S2, wherein the system is configured to change the position associated with a defined node.
S10. The system according to the preceding embodiment, wherein the defined node is different from the re-positioned node.
S11. The system according to the preceding embodiment and with the features of embodiment S4, wherein changing the position comprises incrementing the position, corresponding to a delay in allocating a resource to the defined node.
S12. The system according to any of the 2 preceding system embodiments and with the features of embodiment S8, wherein the system is configured to change the position of the defined node in response to associating the first position with the re-positioned node.
S13. The system according to any of the preceding system embodiments and with the features of embodiment S4, wherein the plurality of resources comprises a next resource, the next resource corresponding to the resource to be allocated next.
S14. The system according to the preceding embodiment, wherein the system is configured to receive the request for re-positioning before the next resource is allocated.
S15. The system according to any of the preceding system embodiments, wherein the system is configured to receive a start signal.
S16. The system according to any of the preceding system embodiments, wherein the system is configured to receive a stop signal.
S17. The system according to any of the preceding system embodiments and with the features of embodiment S15, wherein the system is configured to disallow the request if the request is received before the start signal is received.
S18. The system according to any of the preceding system embodiments and with the features of embodiment S16, wherein the system is configured to disallow the request if the request is received after the stop signal is received.
S19. The system according to any of the preceding system embodiments, wherein the system comprises a communication component configured to receive the request.
S20. The system according to the preceding embodiment and with the features of embodiment S15, wherein the communication component is configured to receive the start signal.
S21. The system according to any of the 2 preceding embodiments and with the features of embodiment S16, wherein the communication component is configured to receive the stop signal.
S22. The system according to any of the preceding system embodiments, wherein the system comprises a data processing component.
S23. The system according to the preceding embodiment and with the features of embodiment S17, wherein the communication component is configured to communicate with the data processing component.
S24. The system according to the preceding embodiment and with the features of any of embodiments S19-S21, wherein the communication component is configured to send any of the request, the start signal, and the stop signal to the data processing component.
S25. The system according to any of the preceding system embodiments, wherein the system comprises a memory component.
S26. The system according to the preceding embodiment and with the features of embodiment S22, wherein the memory component is configured to communicate with the data processing component.
S27. The system according to any of the preceding system embodiments, wherein the request comprises a value.
S28. The system according to the preceding embodiment, wherein re-positioning the node is based, at least in part, on the value.
S29. The system according to any of the preceding system embodiments, particularly with the features of embodiment S24, wherein the system, particularly the data processing component thereof, is configured to determine if the request satisfies a re-positioning condition.
S30. The system according to the preceding embodiment and with the features of embodiment S27, wherein the determination if the request satisfies a re-positioning condition is based, at least in part, on the value.
S31. The system according to any of the 2 preceding embodiments, wherein a result of the determination if the request satisfies a re-positioning condition corresponds to one of success or failure.
S32. The system according to the preceding embodiment, wherein the system is configured to, in response to the result of the determination if the request satisfies a re-positioning condition being success, re-position the node.
S33. The system according to any of the preceding system embodiments, particularly with the features of embodiment S19, wherein the system, particularly the communication component thereof, is configured to receive a plurality of requests for re-positioning.
S34. The system according to the preceding embodiment, wherein each of the plurality of requests is received from one of the plurality of nodes.
S35. The system according to any of the 2 preceding embodiments and with the features of embodiment S27, wherein each of the plurality of requests comprises a value.
S36. The system according to any of the preceding system embodiments, particularly with the features of embodiment S24, and with the features of embodiment S27, wherein the system, particularly the data processing component thereof, is configured to assign a rank to the request based, at least in part, on the value comprised in the request.
S37. The system according to any of the preceding system embodiments, particularly with the features of embodiment S24, and with the features of embodiment S33, wherein the system, particularly the data processing component thereof, is configured to compare a first of the plurality of requests with a second of the plurality of requests.
S38. The system according to the preceding embodiment and with the features of the embodiment S35, wherein the comparison of the first and the second of the plurality of requests is based, at least in part, on the values comprised in the first and the second requests.
S39. The system according to the preceding embodiment and with the features of the embodiment S36, wherein the request corresponds to the first/second request, and wherein the system is configured to assign the rank based, at least in part, on the comparison of the request with another request.
S40. The system according to any of the preceding system embodiments, particularly with the features of embodiment S24, and with the features of embodiment S33, wherein the system, particularly the data processing component thereof, is configured to assign a rank to each of the plurality of requests.
S41. The system according to any of the preceding system embodiments and with the features of embodiment S36, wherein the determination if the request satisfies the re-positioning condition is based, at least in part, on the rank assigned to the request.
S42. The system according to the preceding embodiment, wherein the determination if the request satisfies the re-positioning condition is based, at least in part, on determining if the rank assigned to the request corresponds to a highest rank.
S43. The system according to any of the preceding system embodiments, particularly with the features of embodiment S24, and with the features of embodiment S27, wherein the system, particularly the data processing component thereof, is configured to determine if the value exceeds an allocation threshold.
S44. The system according to the preceding embodiment and with the features of embodiment S29, wherein the determination if the request satisfies the re-positioning condition is based, at least in part, on a result of the determination if the value exceeds the allocation threshold.
S45. The system according to any of the 2 preceding embodiments, wherein the allocation threshold comprises a static threshold.
S46. The system according to any of the 3 preceding embodiments but without the features of the preceding embodiment, wherein the allocation threshold comprises a dynamic threshold.
S47. The system according to the preceding embodiment and with the features of embodiment S4, wherein the allocation threshold is configured to vary based, at least in part, on a number of resources yet to be allocated.
S48. The system according to any of the preceding system embodiments, wherein the system comprises a resource capturing component, wherein the resource capturing component is configured to determine a number of resources yet to be allocated at any moment of time.
S49. The system according to any of the preceding system embodiments and with the features of embodiment S46, wherein the allocation threshold is configured to vary based, at least in part, on a number of nodes in the queue.
S50. The system according to any of the preceding system embodiments, wherein the system comprises a queue capturing component configured to determine a length of the queue at any moment of time.
S51. The system according to any of the preceding system embodiments and with the features of embodiment S31, and S46, wherein the allocation threshold is configured to vary based, at least in part, on a value comprised in a previous request for which the result of the determination if the request satisfied a re-positioning condition corresponded to success.
S52. The system according to the preceding embodiment, wherein the allocation threshold is configured to vary based, at least in part, on values comprised in each of a plurality of previous requests for each of which the result of the determination if the request satisfied a re-positioning condition corresponded to success.
S53. The system according to any of the preceding system embodiments and with the features of embodiment S43, wherein the system is configured to receive the allocation threshold.
S54. The system according to any of the preceding system embodiments and with the features of embodiment S43 but without the features of the preceding embodiment, wherein the system is configured to determine the allocation threshold.
S55. The system according to the preceding embodiment, wherein the system is configured to determine the allocation threshold based, at least in part, on an expected number of nodes in the queue.
S56. The system according to any of the 2 preceding embodiments, wherein the system is configured to determine the allocation threshold based, at least in part, on a temporal variation of an expected number of nodes in the queue.
S57. The system according to any of the 3 preceding embodiments and with the features of embodiment S4, wherein the system is configured to determine the allocation threshold based, at least in part, on an expected number of resources yet to be allocated.
S58. The system according to any of the 4 preceding embodiments, wherein the system is configured to determine the allocation threshold based, at least in part, on a temporal variation of an expected number of resources yet to be allocated.
S59. The system according to any of the preceding system embodiments and with the features of embodiment S27, wherein the system is configured to determine if the value meets/exceeds a validity threshold.
S60. The system according to the preceding embodiment, wherein the system is configured to, in response to the value being less than the validity threshold, disallow the request.
S61. The system according to any of the 2 preceding embodiments, wherein the validity threshold comprises a static threshold.
S62. The system according to any of the 3 preceding embodiments but without the features of the preceding embodiment, wherein the validity threshold comprises a dynamic threshold.
S63. The system according to the preceding embodiment and with the features of embodiment S4, wherein the validity threshold is configured to vary based, at least in part, on a number of resources yet to be allocated.
S64. The system according to any of the 2 preceding embodiments, wherein the validity threshold is configured to vary based, at least in part, on a number of nodes in the queue.
S65. The system according to any of the 3 preceding embodiments and with the features of embodiment S31, wherein the validity threshold is configured to vary based, at least in part, on a value comprised in a previous request for which the result of the determination if the request satisfied a re-positioning condition corresponded to success.
S66. The system according to the preceding embodiment, wherein the validity threshold is configured to vary based, at least in part, on values comprised in each of a plurality of previous requests for each of which the result of the determination if the request satisfied a re-positioning condition corresponded to success.
S67. The system according to any of the preceding system embodiments and with the features of embodiment S59, wherein the system is configured to receive the validity threshold.
S68. The system according to any of the preceding system embodiments and with the features of embodiment S59 but without the features of the preceding embodiment, wherein the system is configured to determine the validity threshold.
S69. The system according to the preceding embodiment, wherein the system is configured to determine the validity threshold based, at least in part, on an expected number of nodes in the queue.
S70. The system according to any of the 2 preceding embodiments, wherein the system is configured to determine the validity threshold based, at least in part, on a temporal variation of an expected number of nodes in the queue.
S71. The system according to any of the 3 preceding embodiments and with the features of embodiment S4, wherein the system is configured to determine the validity threshold based, at least in part, on an expected number of resources yet to be allocated.
S72. The system according to any of the 4 preceding embodiments, wherein the system is configured to determine the validity threshold based, at least in part, on a temporal variation of an expected number of resources yet to be allocated.
S73. The system according to any of the preceding system embodiments and with the features of any of embodiments S29, S43, and S59, wherein the system is configured to send a notification related, at least in part, to a result of the determination.
S74. The system according to any of the preceding system embodiments and with the features of embodiment S31, wherein the system is configured, in response to the determination if the request satisfies a re-positioning condition being success, to generate a readable code.
S75. The system according to the preceding embodiment, wherein the code comprises any of a bar code, a QR-code, a matrix data code, or any other suitable code.
S76. The system according to any of the 2 preceding embodiments, wherein the code comprises a human and/or machine-readable code.
S77. The system according to any of the preceding system embodiments, wherein the system comprises a code scanning component configured to scan a readable code.
S78. The system according to any of the preceding system embodiments and with the features of embodiments S4, and S74, wherein allocating any of the plurality of resources comprises reading the readable code.
S79. The system according to the preceding embodiment, wherein the system is configured to disallow the request if the request is received after a defined time interval has elapsed since reading the last readable code.
S80. The system according to the preceding embodiment, wherein the defined time interval comprises a fixed time interval.
S81. The system according to the preceding embodiment, wherein a length of the defined time interval is less than 5 minutes, preferably less than 3 minutes, further preferably less than 2 minutes.
S82. The system according to any of the preceding system embodiments and with the features of embodiment S79 but without the features of the preceding embodiment, wherein the defined time interval is based, at least in part, on a time required for allocating a resource previously.
S83. The system according to any of the preceding system embodiments and with the features of embodiment S79 but without the features of embodiment S80, wherein the defined time interval is a dynamic time interval.
S84. The system according to the preceding embodiment, wherein the dynamic time interval is based, at least in part, on a statistical moment of times required for allocating a plurality of resources previously.
S85. The system according to any of the preceding system embodiments and with the features of embodiment S4, wherein each of the plurality of resources allocated is associated with a distributor identifier.
S86. The system according to the preceding embodiment, wherein the system is further configured to determine a time at which each of the plurality of resources is allocated to a node.
S87. The system according to the preceding embodiment and with the features of embodiment S83, wherein the dynamic time interval is based, at least in part, on a time interval between two resources associated with the same distributor identifier allocated successively.
S88. The system according to any of the preceding system embodiments, wherein each of the plurality of nodes corresponds to a vehicle, particularly an autonomous vehicle.
S89. The system according to any of the preceding system embodiments and with the features of embodiment S4, wherein the plurality of available resources corresponds to a plurality of free sections that will open up ahead of a pre-defined number of vehicles in a lane.
S90. The system according to any of the preceding system embodiments and with the features of embodiments S74, and S88, wherein the generated code comprises information allowing the (autonomous) vehicle to be identified.
S91. The system according to the preceding embodiment, wherein the generated code comprises a timestamp.
S92. The system according to any of the 2 preceding system embodiments, wherein the system is configured to send the generated code to a central control system of the (autonomous) vehicle.
S93. The system according to any of the preceding system embodiments and with the features of embodiment S90, but without the features of the preceding embodiment, wherein the system is configured to send the generated code to the (autonomous) vehicle.
S94. The system according to any of the preceding system embodiments, wherein the system is configured to perform the method according to any of the preceding method embodiments.

Below central control system embodiments will be discussed. These are abbreviated by the letters “VC” followed by a number. Whenever reference is herein made to the “central control system embodiments”, the following embodiments are meant.
VC1. A central control system configured to control at least one (autonomous) vehicle, wherein the central control system comprises a central communication component, the central communication component configured to communicate with each of the at least one (autonomous) vehicle.
VC2. The central control system according to the preceding embodiment, wherein the central communication component is configured to communicate with a system according to any of the preceding system embodiments and with the features of embodiment S91.
VC3. The central control system according to the preceding embodiment, wherein the central control system is configured to receive a code from the system.
VC4. The central control system according to the preceding embodiment, wherein the central control system is configured, in response to receiving the code, to allow the at least one vehicle to move to a dedicated lane allowing for re-positioning of the at least one vehicle.

Below computer program product embodiments will be discussed. These are abbreviated by the letter “C” followed by a number. Whenever reference is herein made to the “computer program product embodiments”, the following embodiments are meant.
C1. A computer program product comprising instructions, when run on a data processing component of a system according to any of the preceding system embodiments, to cause the system to perform the method according to any of the preceding method embodiments.
C2. A computer program product comprising instructions, when run on a data processing unit of a computer, to cause the computer to perform the method according to any of the preceding method embodiments.

### BRIEF DESCRIPTION OF FIGURES

FIG. 1 depicts an embodiment of a system for re-positioning a node in a queue.

FIG. 1 depicts a system 1 for re-positioning a node in a queue. The system 1 may comprise a communication component 12 configured to at least receive a request for re-positioning from a node 2. The node 2 may be part of a queue comprising a plurality of nodes 2. Each of the plurality of nodes 2 may be associated with a position. The position may relate, at least in part, to an order in which each of the plurality of nodes 2 may receive one of a plurality of available resources. In other words, each of the plurality of resources may be allocated to a distinct node 2. For example, the system 1 may comprise a smartphone, a tablet, a laptop, a desktop, or any suitable computer. The communication component 12 may be configured to communicate with any other component by means of a wired or a wireless connection.

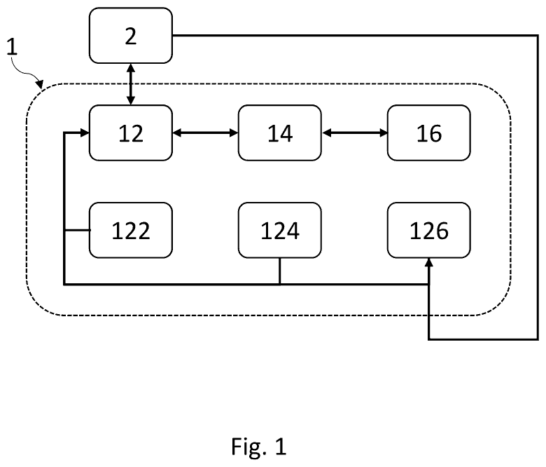

The request for re-positioning may comprise a value. The value may be indicative of an efficiency of utilization of the next available resource by the node 2.

Alternatively, or additionally, the request for re-positioning may comprise data related, at least in part, to the node 2. The data related, at least in part, to the node 2 may comprise data allowing identification of the node 2 from among the plurality of nodes 2 in the queue. For example, each of the plurality of nodes may be associated with a unique identifier and the request may comprise the unique identifier. The request may additionally, or alternatively, comprise a time stamp corresponding to a time when the request is sent by the node 2.

The system 1 may comprise a data processing component 14 configured to communicate with the communication component 12. For example, the data processing component 14 may comprise the data processing component 14 of the computer, smartphone, tablet, laptop, as described above. Communication with the communication component 12 may be understood to comprise exchange of data with the communication component 14.

In particular, the data processing component 14 may comprise a programmable microprocessor with an associated memory, wherein various methods/instructions for determining allocation and/or validity thresholds, or start and/or end times, as described further below, may be programmed and stored for later execution.

The communication component 12 may be configured to send the request for re-positioning, or at least data related thereto, to the data processing component 14. The data processing component 14 may be configured to associate, with the request, a time stamp corresponding to a time at which the request is received.

The system 1 may further comprise a memory component 16 configured to allow storage, access, and retrieval of data. The data processing component 14 may be configured to communicate with the memory component 16, i.e., to exchange data with the memory component 16.

The data processing component 14 may be further configured to determine if the request satisfies a validity condition. Determining if the request satisfies a validity condition may comprise determining if the value in the request meets and/or exceeds a validity threshold. A result of the determination if the value in the request meets and/or exceeds the validity threshold may comprise one of success if the value in the request meets and/or exceeds the validity threshold or failure if the value is less than the validity threshold.

Determining if the request satisfies a validity condition may, additionally, or alternatively, comprise determining if the time at which the data processing component 14 received the request lies in an interval defined by a start time and an end time. In other words, the data processing component 14 may determine if the time at which the request is received is not earlier than the start time and if the time at which the request is received is not later than the end time. A result of the determination if the time at which the request is received lying in an interval defined by a start and an end time may comprise one of success, if the time lies in the interval, or failure, otherwise.

Alternatively, or additionally, the system 1, particularly the communication component 12 thereof, may be configured to receive a start and/or a stop signal. The determination if the request satisfies a validity condition may, then, be based, at least in part, on determining if the request is received after the start signal and/or before the stop signal.

A result of the determination if the request satisfies the validity condition may be success if the result of any of, preferably both of, the determination of the time at which the request is received lying within the interval and/or within the start and/or stop signals and the determination if the value in request meets and/or exceeds the validity threshold is success and may be failure otherwise. The data processing component 14 may be configured to generate a notification based, at least in part, on a result of the determination if the request satisfies the validity condition.

The data processing component 14 may be further configured, in response to the result of the determination if the request satisfies the validity condition, assigning a rank to the request. The data processing component 14 may be configured to assign the rank based, at least in part, on a comparison of the value comprised in the request with a value comprised in a request received previously, wherein the request received previously also satisfied the validity condition. Preferably, a higher rank may be assigned to a request with a higher value. The request received previously may be retrieved, for example, from the memory component 16.

The data processing component 14 may be configured to send the request, or the data related thereto, along with the associated rank to the memory component 16 for storage. The request, or the data related thereto, and the associated rank may be used for assigning a rank to a future request, as described above.

The data processing component 14 may be configured, after the end time has elapsed, to determine the request with the highest rank. In particular, the data processing component 14 may be configured to retrieve all the requests, or the data related thereto, stored in the memory component 16 along with their associated ranks, and to determine the request with the highest rank.

The data processing component 14 may be further configured to determine if the request with the highest rank satisfies an allocation condition. Determining if an allocation condition is satisfied may comprise determining if the value comprised in the request with the highest rank is at least as large as an allocation threshold. A result of the determination may be one of success, if the value is at least as large as the allocation threshold, or failure, otherwise.

In response to the result of the determination if the request with the highest rank satisfies an allocation condition being success, the data processing component 14 may be configured to generate a human-and/or machine-readable code. The code may comprise, for example, a QR code, a bar code, a matrix code, or any other suitable code. The code may, in particular, be readable or scannable by a code scanning component 126 of the system 1.

The code may be sent to the node 2 that sent the request with the highest rank. For example, the data processing component 14 may generate the code and send it to the communication component 12 that may, in turn, send it to the node 2.

In response to the result of the determination if the request with the highest rank satisfies an allocation condition being success, the data processing component 14 may be configured to store a time at which the request with the highest rank was received and the value comprised in the request in the memory component 16. The time and the value may be used, at least in part, to determine a value for the allocation and/or validity threshold in future.

The data processing component 14 may be further configured, in response to the result of the determination if the request with the highest rank satisfies the allocation condition being success, to re-position the node 2 that sent the request with the highest rank. Re-positioning the node 2 may comprise associating the first position with the node 2 such that the node 2 is the node to which the next available resource is allocated. Re-positioning may further comprise updating the positions of any, preferably each, of the other nodes 2 in the queue. In particular, the positions may be updated such that any other node 2 is allocated an available resource with a delay.

Thus, embodiments of the present technology may allow re-positioning of nodes in a queue more efficiently and robustly as the resource is allocated to the node with the highest value.

The system 1, particularly the data processing component 14 thereof, may be configured to receive and/or determine any of the start time or signal, the end time or signal, the validity threshold, and the allocation threshold. In particular, the system 1 may comprise any of a queue capturing component 122, a resource capturing component 124, or the code scanning component 126, as described above.

The queue capturing component 122 may be configured to determine a length of the queue of nodes 2 at any moment of time. For example, the queue capturing component 122 may be configured to capture an image or an audio of the queue. The image may comprise an optical image, a thermal image, or any other suitable image. The queue capturing component 122 may additionally, or alternatively, be configured to capture data related, at least in part, to a location of any of the plurality of nodes 2. The queue capturing component 122 may be configured to receive data related, at least in part, to the length of the queue from an external device, such as a counter at a gated entry point to the queue. The queue capturing component 122 may be configured to send the captured data to the data processing component 14, for example, via the communication component 12.

The data processing component 14 may be configured to determine the length of the queue based, at least in part, on the captured data. The data processing component 14 may send the captured data to the memory component 16. In some embodiments, the data processing component 14 may alternatively, or additionally, send the determined length of the queue based, at least in part, on the captured data, together with a time stamp of the time at which the data was captured, to the memory component 16 for storage.

Alternatively, or additionally, the data processing component 14 may be configured to estimate a length of the queue based, at least in part, on a current time and historical data related, at least in part, to the length of the queue. For example, the data processing component 14 may be configured to retrieve the data from the memory component 16 and estimate the length of the queue based, at least in part, thereupon.

The resource capturing component 124 may be configured to determine a number of available resources remaining at any moment of time. The number of available resources remaining may be determined based, at least in part, on a pre-determined total number of available resources and a number of the resources already allocated. A resource may be allocated only temporarily such that it can be allocated and then freed up. In this case, the number of available resources remaining may also be determined based, for example, on the allocation and freeing up of a resource.

The code scanning component 126 may comprise, for example, an image sensor.

The code scanning component 126 may be further configured, in response to having scanned a code, to send a notification to the data processing component 14, optionally via the communication component 12. For example, the system 1, particularly the communication component 12 thereof, may be configured to receive a notification from the code scanning component 126 in response to having scanned a code. The communication component 12 may be configured to send the notification to the data processing component 14.

The receipt of the notification by the data processing component 14 may be used, for example, to set, at least in part, the start or end time or may correspond to the start or stop signal as described above. In other words, the scanning of the code may be used to trigger the start or the end of the ranking of requests.

The system 1 may comprise the code scanning component 126, as described above. However, in some embodiments, the system 1 may not comprise a dedicated code scanning component 126 but may, rather, receive a notification corresponding to a code having been scanned from an external code scanning component.

The start and/or end time may be determined, at least in part, based on a time needed to allocate a resource to a node. For example, once a code has been scanned by the code scanning component 126, the system 1 may be configured to trigger allocation of the next available resource to the corresponding node 2.

The scanning of the code may also trigger the start time such that requests for re-positioning received later than the notification of the code having been scanned, as described above, by the data processing component 14 may satisfy the validity condition. The end time may be determined as a time after a defined time interval has elapsed since the start time. The defined time interval may be a fixed time interval, such as 90 seconds, or may be a dynamic time interval that may be based, for example, on a time needed to allocate a resource.

The system 1 may be configured to determine a time at which a resource has been allocated to a node 2. For example, the system 1 may receive a corresponding notification (of a resource having been allocated) and a time at which such notification is received by the system 1 may be determined as the time at which the resource has been allocated to a node 2. Alternatively, or additionally, the system 1 may be configured, for example, to capture image and/or audio data related, at least in part, to the allocation of a resource to a node 2 and based, at least in part, thereupon, determine the time at which a resource has been allocated to a node 2.

The dynamic time interval may, additionally, or alternatively, be based, at least in part, on a length of the queue of nodes and/or a number of available resources at a current time. The use of a dynamic time interval may be of particular advantage in ensuring that resources are distributed so as to maximize utilization efficiency.

In some embodiments, the allocation of a resource to a node 2 may be, at least significantly, contemporaneous with the code scanning component 126 scanning the code. In such embodiments, a fixed time interval may be preferably used.

In other embodiments, however, there may be a finite time interval between the code having been scanned and the resource having been allocated to the node 2 with the highest rank. In such embodiments, a dynamic defined time interval may be preferable.

Further exemplarily, the system 1 may be configured to receive requests at any time and the end time or the stop signal may be based, at least in part, on the scanning of a code by the code scanning component 126.

Any of the allocation and validity thresholds, as described above, may be based, at least in part, on the determined/estimated length of the queue of nodes 2 and/or the number of available resources remaining. In particular, the allocation and/or the validity threshold may vary proportionally to the length of the queue and/or in inverse proportion to the number of available resources remaining.

Any of the allocation and validity thresholds, as described above, may be based, at least in part, on the value(s) in previous request(s) of the highest rank(s). For example, an average of such values may be used as the allocation threshold. Further, an average of such values for previous request(s) received at similar times may be used, with an appropriate choice of similarity. For example, the allocation value may be set to be an average of the values comprised in previous requests of the highest rank, as stored in the memory component 16, that were received within 20 minutes of the current time, or within a current 1-hour block. For example, the allocation value for any request received between 21.00 and 22.00 may be set to be the average, or a fraction thereof, of values comprised in previous requests of the highest rank that were received between 21.00 and 22.00.

The system 1, as described above, may be of particular advantage in traffic management of autonomous vehicles, for example. In particular, autonomous vehicles may correspond to nodes as described above and may send requests for re-positioning. Requests may be sent by a vehicle autonomously or may be initiated by a user/owner of the vehicle. Once a request sent by a vehicle has been approved, the system 1 may generate a code containing a unique identifier that may indicate, inter alia, information allowing identification of the vehicle and a timestamp. The generated code may be stored in the memory component 16 of the system 1 and may be used to verify that the request of the vehicle has been approved. The vehicle may then be allowed to re-position itself ahead of other vehicles, thus skipping traffic, for example.

A dedicated lane may be provided to enable the vehicle to re-position itself ahead of other vehicles, for example. A sensor, such as a camera, may be provided on the dedicated lane to identify vehicles that ply on the dedicated lane and may be used to verify that only vehicles with approved requests travel on the dedicated lane. However, other sensors may also be provided that may allow, for example, reading a Vehicle Identification Number (VIN) of the vehicle such as an RFID sensor. Alternatively, the autonomous vehicle may be controlled by a central control system that may, for example, receive the generated code from the system 1 and, in response, permit the autonomous vehicle to move to the dedicated lane. Further alternatively, the generated code may be sent to the autonomous vehicle that may then send it, or at least a part thereof, to the central control system for permission to move to the dedicated lane. In such embodiments, the central control system may perform functions of the code scanning component 126, as described above. In particular, the central control system may comprise a central communication component configured to communicate with at least one (autonomous) vehicle and with the system 1, particularly the communication component 12 thereof.

The plurality of resources may correspond to a plurality of free sections that will open up ahead of a pre-defined number of vehicles in a lane. Moreover, the plurality of resources may comprise different types of resources, each type defined by a value of the pre-defined number. For example, a first plurality of resources may correspond to free sections that will open up ahead of 2 vehicles, whereas a second plurality of resources may correspond to free sections that will open up ahead of 10 vehicles. The validity and/allocation threshold may then vary based, at least in part, on the value of the pre-defined number of vehicles. The values of the pre-defined number may be set, for example, by a traffic authority of an area.

As described above, the queue capturing component 122 may be used to determine or estimate, for example, a number (density) of vehicles in a lane or any other lane than the dedicated lane that may be representative of the number of nodes in the queue. The resource capturing component 124 may, on the other hand, not be needed in this situation as there will always be free sections opening up in any lane. Alternatively, free sections may become unavailable for all nodes (vehicles) due to a lane closure, or a vehicle breakdown.

Overall, embodiments of the present technology may thus allow re-positioning of nodes in a queue that may allow for more efficient and robust allocation of resources.

The system 1 has been described above as having a number of components, but any one or more of these components may be omitted or duplicated, as suitable for the application and setting. These components may include one or more of a data processing component 14, a memory component 16, a communication component 12, battery/power circuitry, a display component, and other input/output (I/O) components such as a queue capturing component 122, a resource capturing component 124, or a code scanning component 126, as will be described below.

In one or more embodiments, one or more of the components included in the system 1 may be attached to one or more motherboards and enclosed in a housing (e.g., including plastic, metal, and/or other materials). In one or more embodiments, some of these components may be fabricated onto a single system-on-a-chip (SoC) (e.g., an SoC may include one or more data processing components 14 and one or more memory components 16). Additionally, in one or more embodiments, the system 1 may omit one or more of the components 14, 16. In one or more embodiments, the system 1 may include interface circuitry for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the system 1 may omit a dedicated display component, but may include display component interface circuitry (e.g., a connector and driver circuitry) to which a display component may be coupled.

The system 1 may include the data processing component 14 (e.g., one or more data processing components 14). As used herein, the term “data processing component” may refer to any device or portion of a device that processes electronic data from registers and/or memory to transform that electronic data into other electronic data that may be stored in registers and/or memory. The data processing component 14 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing components.

The system 1 may include a memory component 16 (e.g., one or more memory components 16). The memory component 16 may include one or more memory components such as random-access memory (RAM) (e.g., static RAM (SRAM) components, magnetic RAM (MRAM) components, dynamic RAM (DRAM) components, resistive RAM (RRAM) components, or conductive-bridging RAM (CBRAM) components), hard drive-based memory components, solid-state memory components, networked drives, cloud drives, or any combination of memory components. In one or more embodiments, the memory component 16 may include memory that shares a die with the data processing component 14. In such an embodiment, the memory component 16 may be used as cache memory and may include embedded dynamic random-access memory (eDRAM) or spin transfer torque magnetic random-access memory (STT-MRAM), for example. In one or more embodiments, the memory component 16 may include non-transitory computer readable media having instructions, in form of a computer program product for example, thereon that, when executed by one or more data processing components (e.g., the data processing component 14), cause the system 1 to perform any appropriate ones of or portions of the methods disclosed herein.

The system 1 may include a communication component 12 (e.g., one or more communication components 12). The communication component 12 may include one or more communication chips, connectors, and/or other hardware and software to govern communications between the system 1 and other computing components. For example, the communication component 12 may include circuitry for managing wireless communications for the transfer of data to and from the system 1. The term “wireless” and its derivatives may be used to describe circuits, components, systems, methods, techniques, communications channels, etc., that may communicate data through the use of modulated electromagnetic radiation through a nonsolid medium. The term does not imply that the associated components do not contain any wires, although in one or more embodiments the associated components might not contain any wires. Circuitry included in the communication component 12 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In one or more embodiments, circuitry included in the communication component 12 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In one or more embodiments, circuitry included in the communication component 12 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In one or more embodiments, circuitry included in the communication component 12 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In one or more embodiments, the communication component 12 may include one or more antennas (e.g., one or more antenna arrays) for receipt and/or transmission of wireless communications.

In one or more embodiments, the communication component 12 (or, equivalently, the central communication component) may include circuitry for managing wired communications, such as electrical, optical, or any other suitable communication protocols. For example, the communication component 12 may include circuitry to support communications in accordance with Ethernet technologies. In one or more embodiments, the communication component 12 may support both wireless and wired communication, and/or may support multiple wired communication protocols and/or multiple wireless communication protocols. For example, a first set of circuitry of the communication component 12 may be dedicated to shorter-range wireless communications such as Wi-Fi or Bluetooth, and a second set of circuitry of the communication component 12 may be dedicated to longer-range wireless communications such as global positioning system (GPS), EDGE, GPRS, CDMA, WiMAX, LTE, EV-DO, or others. In one or more embodiments, a first set of circuitry of the communication component 12 may be dedicated to wireless communications, and a second set of circuitry of the communication component 12 may be dedicated to wired communications.

The system 1 may include battery/power circuitry. The battery/power circuitry may include one or more energy storage components (e.g., batteries or capacitors) and/or circuitry for coupling components of the system 1 to an energy source separate from the system 1 (e.g., AC line power).

The system 1 may include a display component (e.g., multiple display component). The display component may include any visual indicators, such as a heads-up display, a computer monitor, a projector, a touchscreen display, a liquid crystal display (LCD), a light-emitting diode display, or a flat panel display.

The system 1 may include other input/output (I/O) components such as a queue capturing component 122, a resource capturing component 124, or a code scanning component 126. Any of the queue capturing component 122, the resource capturing component 124, or the code scanning component 126 may include one or more audio output components (e.g., speakers, headsets, earbuds, alarms, etc.), one or more audio input components (e.g., microphones or microphone arrays), location components (e.g., GPS components in communication with a satellite-based system to receive a location of the system 1, or at least a part thereof, as known in the art), audio codecs, video codecs, printers, sensors (e.g., thermocouples or other temperature sensors, humidity sensors, pressure sensors, vibration sensors, accelerometers, gyroscopes, etc.), image capture components such as cameras, keyboards, cursor control components such as a mouse, a stylus, a trackball, or a touchpad, bar code readers, Quick Response (QR) code readers, or radio frequency identification (RFID) readers, for example.

The system 1 may have any suitable form factor for its application and setting, such as a handheld or mobile computing component (e.g., a cell phone, a smart phone, a mobile internet component, a tablet computer, a laptop computer, a netbook computer, an ultrabook computer, a personal digital assistant (PDA), an ultra-mobile personal computer, etc.), a desktop computing component, a server computing component, or another networked computing component. Moreover, different components of the system 1 may or may not be comprised in an integral unit. In particular, the other I/O components, as described above, may be different integral unit(s) with respect to other components of the system 1.

While in the above, a preferred embodiment has been described with reference to the accompanying drawings, the skilled person will understand that this embodiment was provided for illustrative purpose only and should by no means be construed to limit the scope of the present invention, which is defined by the claims.

Whenever a relative term, such as “about”, “substantially” or “approximately” is used in this specification, such a term should also be construed to include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A method for re-positioning a node in a queue, wherein the queue comprises a plurality of nodes, and wherein the method comprises:
receiving, from the node, a request for re-positioning, and
allocating each of a plurality of resources to at least some of the plurality of nodes.

2. The method according to the preceding claim, wherein each of the plurality of nodes in the queue is associated with a position, wherein the position relates, at least in part, to an order in which each of the plurality of resources is to be allocated to each of the plurality of nodes.

3. The method according to the preceding claim, wherein the plurality of nodes comprises a node associated with a first position, wherein the node associated with the first position corresponds to a node to which a next of the plurality of resources is allocated, wherein re-positioning the node comprises associating the first position with the re-positioned node, corresponding to the re-positioned node becoming the node to which the next of the plurality of resources is allocated.

4. The method according to any of the preceding claims, wherein the request comprises a value, wherein re-positioning the node is based, at least in part, on the value.

5. The method according to any of the preceding claims, wherein the method comprises determining if the request satisfies a re-positioning condition, wherein a result of the determination if the request satisfies a re-positioning condition corresponds to one of success or failure, wherein the method comprises, in response to the result of the determination if the request satisfies a re-positioning condition being success, re-positioning the node.

6. The method according to any of the preceding claims and with the features of claim 4, wherein the method comprises determining if the request satisfies an allocation condition comprising determining if the value exceeds an allocation threshold.

7. The method according to the preceding claim and with the features of claim 5, wherein the determination if the request satisfies the re-positioning condition is based, at least in part, on a result of the determination if the value exceeds the allocation threshold.

8. The method according to any of the 2 preceding claims, wherein the allocation threshold comprises a dynamic threshold, wherein the allocation threshold is configured to vary based, at least in part, on a number of resources yet to be allocated and/or wherein the allocation threshold is configured to vary based, at least in part, on a number of nodes in the queue.

9. The method according to any of the preceding claims and with the features of claim 5, wherein the method comprises, in response to the determination if the request satisfies a re-positioning condition being success, generating a readable code.

10. A system for re-positioning a node in a queue, wherein the queue comprises a plurality of nodes, and wherein the system is configured to:
receive, from the node, a request for re-positioning, and
to allocate each of a plurality of resources to at least some of the plurality of nodes.

11. The system according to the preceding claim, wherein the system comprises:
a communication component configured to receive the request, and
a data processing component,
wherein the communication component is configured to communicate with the data processing component.

12. The system according to the preceding claim, wherein the system, particularly the data processing component thereof, is configured to determine if the request satisfies a re-positioning condition.

13. The system according to any of the 3 preceding claims, wherein the system is configured to receive a plurality of requests, wherein each of the plurality of requests is received from one of the plurality of nodes.

14. The system according to any of the 4 preceding claims, wherein the system comprises any of:
a queue capturing component configured to determine a length of the queue at any moment of time,
a resource capturing component, wherein the resource capturing component is configured to determine a number of resources yet to be allocated at any moment of time, and
a code scanning component configured to scan a readable code.

15. A computer program product comprising instructions, when run on a data processing component of a system according to any of the claims 11-14, to cause the system to perform the method according to any of the claims 1-9.
